(19) United States
(12) Patent Application Publication
(10) Pub. No.: US 2026/0259440 A1
(43) Pub. Date: Sep. 3, 2026

(54) OPTICAL ELEMENT

(71) Applicant: OSAKA UNIVERSITY, Osaka (JP)

(72) Inventors: Hidetsugu YOSHIDA, Osaka (JP); Shigeki TOKITA, Osaka (JP); Junji KAWANAKA, Osaka (JP); Koji TSUBAKIMOTO, Osaka (JP)

(21) Appl. No.: 18/873,153

(22) PCT Filed: Jun. 6, 2023
(86) PCT No.: PCT/JP2023/020916

§ 371 Date: Dec. 9, 2024

(30) Foreign Application Priority Data
Jun. 13, 2022 (JP) 2022-095172

(51) Int. Cl. G02F 1/09

(52) U.S. Cl. CPC G02F 1/093

(57) ABSTRACT

Provided is a Faraday rotator that is small, inexpensive, and capable of withstanding high-output and high-repetition laser radiation. An optical element (100) includes: a Faraday rotation element (110) that is reflective and rotates a polarization plane of reflected light with respect to a polarization plane of incident light; a magnet (130) provided on a side opposite to a surface of the Faraday rotation element through which surface the incident light enters the Faraday rotation element; and a coolant circulation section 140 and/or a cryostat (150) that cool(s) the Faraday rotation element.

### TECHNICAL FIELD

The present invention relates to an optical element.

### BACKGROUND ART

In Patent Literature 1, a heat dissipation substrate which has a thermal conductivity higher than that of a Faraday rotation element and does not have birefringence is joined to the Faraday rotation element so that heat of the Faraday rotation element is dissipated.

### CITATION LIST

### Patent Literature

[Patent Literature 1]

Japanese Patent Application Publication, Tokukai, No. 2010-134066

### SUMMARY OF INVENTION

### Technical Problem

However, Faraday rotators that are capable of withstanding high-output and high-repetition laser radiation tend to be large and costly. As such, Faraday rotators are a major bottleneck in development of a high-output and high-repetition laser.

It is an object of an aspect of the present invention to provide a Faraday rotator that is small, inexpensive, and capable of withstanding high-output and high-repetition laser radiation.

### Solution to Problem

In order to attain the object, an optical element in accordance with an aspect of the present invention is an optical element, including: a Faraday rotation element that is reflective and rotates a polarization plane of reflected light with respect to a polarization plane of incident light; a magnet provided on a side opposite to a surface of the Faraday rotation element through which surface the incident light enters the Faraday rotation element; and a cooling section provided between the Faraday rotation element and the magnet, the cooling section cooling the Faraday rotation element.

### Advantageous Effects of Invention

According to an aspect of the present invention, it is possible to provide a Faraday rotator that is small, inexpensive, and capable of withstanding high-output and high-repetition laser radiation.

### BRIEF DESCRIPTION OF DRAWINGS

FIG. 1 is a view illustrating a configuration of main parts of an optical system including an optical element in accordance with Embodiment 1.

FIG. 2 illustrates a result of measurement of a magnetic flux density (vertical axis) in relation to a distance from a center of a magnet (horizontal axis).

FIG. 3 illustrates an experimental result indicating a change in rotation angle of a polarization plane when a temperature is changed.

FIG. 4 illustrates an experimental result indicating a distribution of power intensities in relation to respective polarization angles.

FIG. 5 illustrates an experimental result indicating a distribution of rotation angles in a radial direction of a laser spot.

FIG. 6 illustrates a Verdet constant (rad/Tm) of TGG depending on temperature (K).

FIG. 7 is a view illustrating a configuration of main parts of an optical system including an optical element in accordance with Embodiment 2.

FIG. 8 is a view illustrating a configuration of main parts of another optical system including the optical element in accordance with Embodiment 2.

FIG. 9 is a view illustrating a configuration of main parts of an optical system including an optical element in accordance with Embodiment 3.

FIG. 10 is a view illustrating a configuration of main parts of an optical system including an optical element in accordance with Embodiment 4.

FIG. 11 is a cross-sectional view schematically illustrating a configuration of an optical element in accordance with Comparative Example.

### DESCRIPTION OF EMBODIMENTS

### Embodiment 1

Before describing Embodiment 1 of the present invention, the following description will first describe Comparative Example.

### (Comparative Example)

FIG. 11 is a cross-sectional view schematically illustrating a configuration of an optical element 200 in accordance with Comparative Example. The optical element 200 is an optical element which includes: a donut-shaped magnet 230; and a Faraday rotation element 210 provided at a center part at which a magnetic field of the magnet 230 is concentrated. Light incident on the optical element 200 passes through the optical element 200 while the magnetic field of the magnet 230 acts on the Faraday rotation element 210 to rotate a polarization plane of the incident light. The optical element 200 is used at room temperature.

The optical element 200, for example, has a cylindrical shape of approximately 236 mm in diameter and 240 mm in length and has a weight of approximately 80 kg. Most of the weight is accounted for by a weight of the magnet 230 which generates a magnetic force of 1.5 T at the center part. As such, the optical element 200 is costly for being extremely large and heavy. Note that the optical element 200 has a Verdet constant at 300 K of 35 rad/Tm.

Further, the optical element 200 has a structure that makes it difficult for heat to escape. As such, heat builds up due to a laser beam entering the optical element 200, so that a significant thermal lens effect and a significant thermal birefringence effect are exhibited. The optical element 200 is therefore not suitable for continuous use. Furthermore, since a polarization plane of the laser beam is rotated while the laser beam passes, it is necessary to have one optical element 200 per optical path.

### (Configuration of Optical System 1)

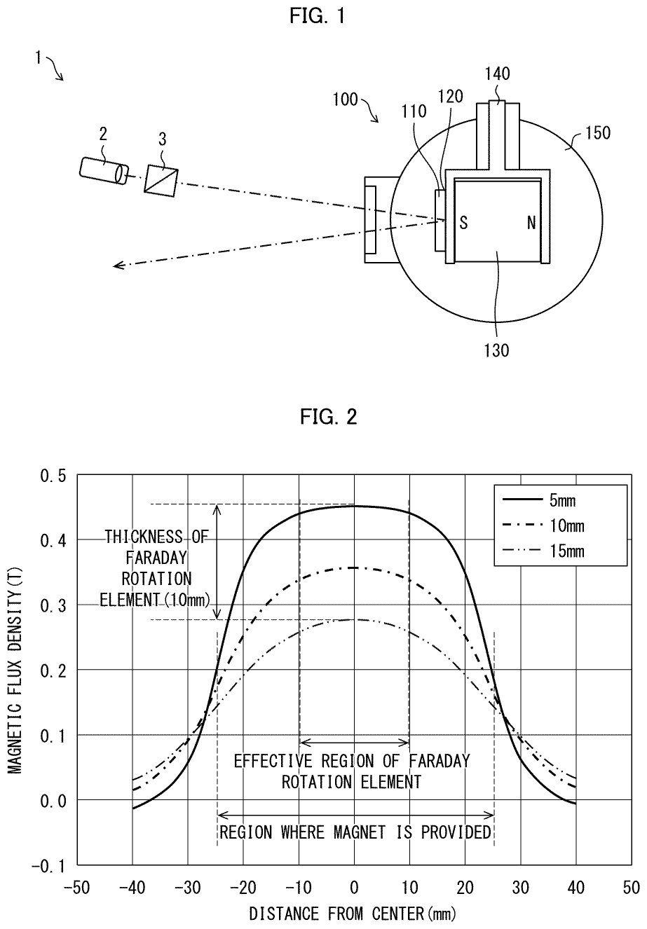

The following description will discuss an embodiment of the present invention in detail with reference to FIGS. 1 to 6.

FIG. 1 is a view illustrating a configuration of main parts of an optical system 1 including an optical element 100 in accordance with Embodiment 1. The optical system 1 includes a laser light source 2, a polarizing plate 3, and the optical element 100.

The laser light source 2 is a high-power and high-repetition laser light source. For example, the laser light source 2 is a laser light source (YAG) that emits a laser beam (wavelength: 1030 nm) having an energy of 100 J per pulse and a pulse frequency of 100 Hz. The polarizing plate 3 is an optical element for improving the quality of a polarization state of light emitted from the laser light source 2 by allowing only polarized light in a specific direction among the emitted light to pass through.

The optical element 100 is an optical element including a reflective Faraday rotation element 110. The optical element 100 has a function of rotating a polarization plane of reflected light with respect to a polarization plane of incident light.

### (Configuration of Optical Element 100)

The optical element 100 includes the Faraday rotation element 110, a mirror 120, a magnet 130, a coolant circulation section 140 (cooling section), and a cryostat 150 (cooling section).

The Faraday rotation element 110 rotates, in accordance with an applied magnetic field, a polarization plane of light passing through the Faraday rotation element 110. The Faraday rotation element 110 allows light that has entered the optical element 100 to enter the Faraday rotation element 110. The Faraday rotation element 110 may be a single crystal of terbium gallium garnet (TGG: Tb₃Ga₅O₁₂), or other objects in which Faraday rotation occurs (for example, Tb₃A₁₅O₁₂ (TAG), Tb₃Sc₂Al₃O₁₂ (TSAG), and glass materials FR-5(HOYA), FR25N, and the like).

The mirror 120 is a light-reflecting mirror which is coated on a surface (rear surface) of the Faraday rotation element 110 opposite to a surface through which incident light enters the Faraday rotation element 110. As such, the mirror 120 reflects the incident light, which has entered the Faraday rotation element 110, into reflected light which passes through the Faraday rotation element again. The mirror 120 may be a thin film layer obtained by depositing a metal on one surface (the surface opposite to the surface through which the incident light enters) of the Faraday rotation element 110. Alternatively, the mirror 120 may be a multilayer film of an inorganic oxide such as SiO₂ or ZrO₂ laminated on the one surface of the Faraday rotation element 110.

That is, light that has entered the optical element 100 passes through the Faraday rotation element 110 twice by being reflected by the mirror 120. As such, the optical element 100 is capable of rotating a polarization plane twice as many times as in a case where light is simply caused to enter and pass through the Faraday rotation element.

The magnet 130 is a magnet provided on a side opposite to the surface through which the incident light enters the Faraday rotation element. The magnet 130 is a so-called slab-type magnet and has a south pole face and a north pole face. The magnet 130 is provided such that the south pole face or the north pole face of the magnet 130 is parallel to the surface of the Faraday rotation element through which surface the incident light enters. That is, in the Faraday rotation element 110, a magnetic field formed by the magnet 130 is perpendicular to the surface of the Faraday rotation element 110 through which surface the incident light enters. The magnet 130 is, for example, a magnet which is in the shape of a block of 50 mm×50 mm (a size of a face parallel to the Faraday rotation element 110)×48 mm (thickness) and has a magnetic force of 0.4 T. In order to create a magnetic field that is uniform in an optical path of light, the faces of the magnet 130 each having a magnetic pole may be larger than a diameter of a beam. Further, the faces of the magnet 130 each having a magnetic pole may be larger than the surface of the Faraday rotation element 110 through which surface the incident light enters.

The coolant circulation section 140 is provided between the Faraday rotation element 110 and the magnet 130. The coolant circulation section 140 is in contact with the mirror 120. The coolant circulation section 140 includes a pipe inside which a coolant is passed through and circulates. The coolant circulation section 140 has the role of cooling the Faraday rotation element 110 by absorbing heat of the Faraday rotation element 110 through the mirror 120. As the coolant, liquid nitrogen or liquid helium is preferably used. The coolant circulation section 140 is preferably made of a material having a high thermal conductivity, for example, copper, sapphire, or other metals.

The cryostat 150 is a container which contains all of the other configurations of the optical element 100, and an inside of the cryostat 150 is cooled. A method of cooling the cryostat is not particularly limited. The cryostat 150 has a light-transmitting window for a laser beam to enter and/or exit the cryostat 150. The cryostat 150 may be one which uses liquid nitrogen or liquid helium.

### (Result of Measurement of Magnetic Force)

FIG. 2 illustrates a result of measurement of a magnetic flux density (vertical axis) in relation to a distance from a center of the magnet 130 (horizontal axis). That is, in FIG. 2, a distance Z from a face (the south pole or the north pole) of the magnet 130 is changed, and a distribution of magnetic flux densities on a plane is measured. In a case where the Faraday rotation element 110 in the optical element 100 is 5 mm in thickness, a substantially uniform magnetic flux density of approximately 0.45 T is obtained over a 20-mm-wide region on the surface of the Faraday rotation element 110 through which surface the incident light enters. In a case where the Faraday rotation element 110 is 10 mm in thickness, a substantially uniform magnetic flux density of approximately 0.35 T is obtained over a 20-mm-wide region on the surface of the Faraday rotation element 110 through which surface the incident light enters.

The following description will verify an effect of Faraday rotation in these magnetic field environments in the optical element 100 in accordance with the present embodiment.

### (Inspection of Rotation Angle of Polarization Plane)

For inspection of a rotation angle of a polarization plane of reflected light relative to incident light, a second polarizing plate (not illustrated) was provided on a side where the reflected light would exit, and a power meter (not illustrated) was provided on a secondary side thereof. A polarization plane of the second polarizing plate was manipulated so as to maximize a measured value of power of the reflected light measured by the power meter, and an angle of a second polarization plane at the time when the measured value of the power was maximized was measured. An angle of the polarizing plate 3 was also measured. A difference between these angles indicates how much the polarization plane of the reflected light was rotated with respect to the polarization plane of the incident light.

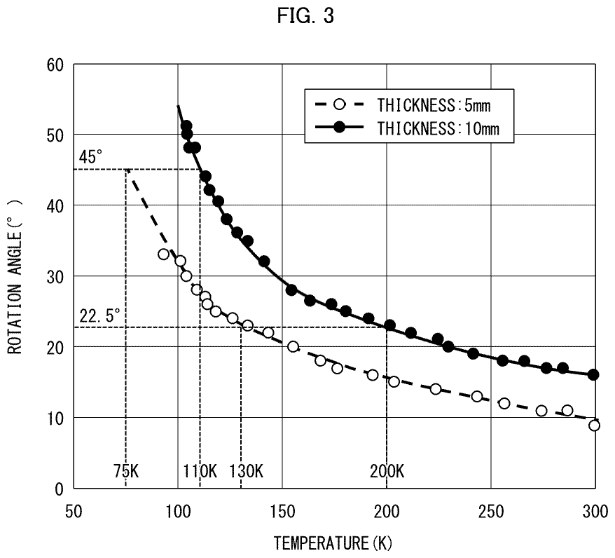

FIG. 3 illustrates an experimental result indicating a change in rotation angle of a polarization plane when a temperature is changed. In FIG. 3, a horizontal axis indicates a temperature (K), and a vertical axis indicates a rotation angle (°) of the polarization plane. As indicated in FIG. 3, the experiment was conducted with use of a 5-mm-thick Faraday rotation element 110 and a 10-mm-thick Faraday rotation element 110 each. An incident angle of light with respect to the Faraday rotation element 110 was 5°.

As indicated in FIG. 3, it was found that in a case where the Faraday rotation element 110 had a thickness of 5 mm, the polarization plane was rotated by 22.5° at 130 K, and the polarization plane would therefore be rotated by 45° at 75 K. It was also found that in a case where the Faraday rotation element 110 had a thickness of 10 mm, the polarization plane was rotated by 22.5° at 200 K and 45° at 110 K. Therefore, the optical element 100 can suitably be used as an isolator or the like.

Note that the result of 22.5° was also measured because Embodiment 2 describes an embodiment in which the polarization plane is rotated by 22.5°. This will be described in detail later.

### (Inspection of Distribution of Intensities in Relation to Respective Polarization Angle)

Subsequently, a distribution of intensities in relation to respective polarization angles was inspected. In the inspection, a change in value of power measured by a power meter was measured while the second polarizing plate was rotated. Then, values obtained by normalization with respect to a maximum value among the measured values of power were considered.

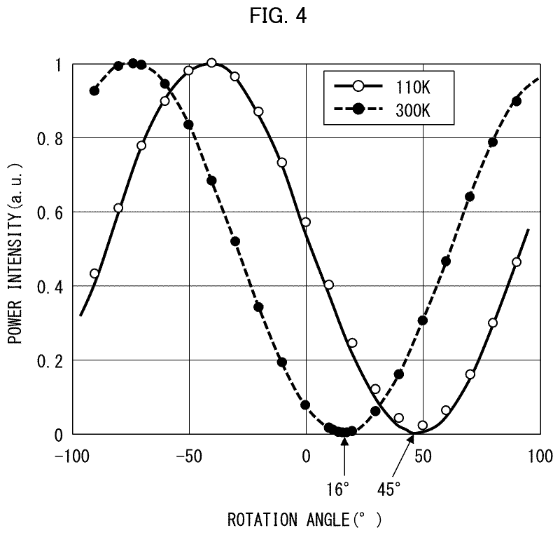

FIG. 4 illustrates an experimental result indicating a distribution of power intensities in relation to respective polarization angles. In FIG. 4, a horizontal axis indicates a rotation angle (°) of the polarization plane, and a vertical axis indicates a measured value of power intensity (a.u.). In the experiment, a 10-mm Faraday rotation element was used, and the measurement was carried out for a case where the Faraday rotation element 110 had a temperature of 300 K and for a case where the Faraday rotation element 110 had a temperature of 110 K. As indicated in FIG. 4, sine waves were obtained.

### (Inspection of Rotation Angle in Radial Direction of Faraday Rotation Element 110)

Further, inspection was conducted on a distribution of rotation angles in relation to respective positions at which a beam entered the Faraday rotation element 110. Specifically, a laser beam having a small diameter was caused to enter the Faraday rotation element 110, and the beam was subjected to translation on a plane parallel to the Faraday rotation element 110. Thus, a distribution of rotation angles in a radial direction of the Faraday rotation element 110 was inspected.

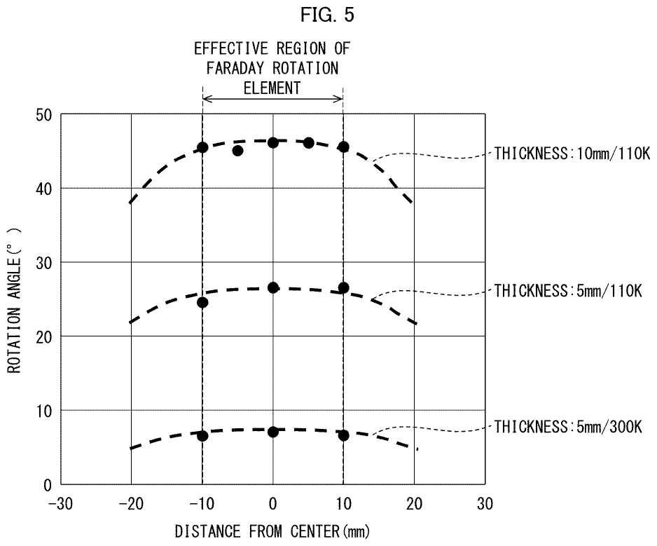

FIG. 5 is an experimental result indicating a distribution of rotation angles in a radial direction of a laser spot. In FIG. 5, a horizontal axis indicates a distance (mm) from a center of the magnet 130 (a center of the Faraday rotation element 110) to the laser spot, and a vertical axis indicates a rotation angle (°) of the polarization plane. The experiment was conducted for a 10-mm Faraday rotation element in a 110 K environment and for a 5-mm-thick Faraday rotation element in a 110 K environment and a 300 K environment.

From the respective results, it was found that, in a case where the distance from the center of the Faraday rotation element 110 was −10 mm to 10 mm (effective region of the Faraday rotation element), a substantially constant rotation angle was obtained. It is thus possible to uniformly rotate the polarization plane in the effective region of the Faraday rotation element. That is, it can be said that the Faraday rotation element 110 is useful.

Further, from a comparison between the result of the 5-mm-thick Faraday rotation element 110 at 110 K and the result of the 5-mm-thick Faraday rotation element 110 at 300 K, it is clear that the rotation angle is increased at low temperature.

### (Verdet Constant)

As described above, the Faraday rotation element 110 rotates a polarization plane of reflected light with respect to a polarization plane of incident light by the Faraday effect. As a proportionality constant for calculating a rotation angle of the rotation caused by the Faraday effect, the Verdet constant is known.

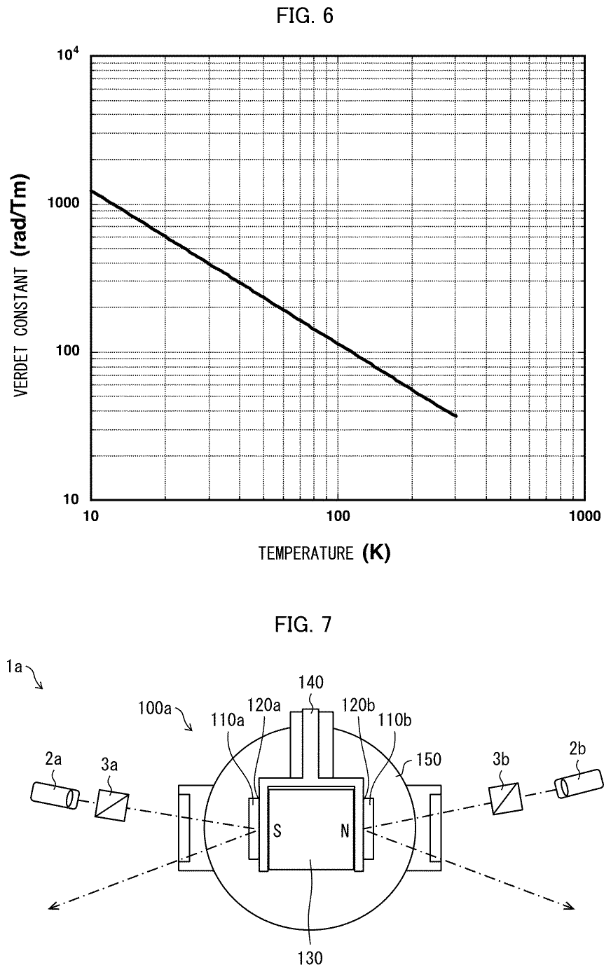

FIG. 6 illustrates a Verdet constant (rad/Tm) of TGG depending on a temperature (K). As indicated in FIG. 6, the Verdet constant is inversely proportional to an absolute temperature. For example, the Verdet constant is 35 rad/Tm at 300 K, 60 rad/Tm at 200 K, 110 rad/Tm at 100 K, and 165 rad/Tm at 70 K. It is therefore important to cool the Faraday rotation element 110.

### (Conclusion)

The above description has indicated the optical element 100 in which the Verdet constant is increased by cooling the Faraday rotation element with use of the coolant circulation section 140 and/or the cryostat 150, so that the polarization plane is rotated by a required angle even in a case where the magnet 130 having low magnetic force is used.

The optical element 100 in accordance with Embodiment 1 has a weight which is approximately 1/60 of the weight of the optical element 200 in accordance with Comparative Example and a magnetic force which is approximately ½ to ⅓ of the magnetic force of the optical element 200. Thus, the optical element 100 is small and inexpensive. This enables forced cooling of the optical element 100 with use of the cooling sections. Further, due to the cooling, heat from laser radiation is not retained unlike in Comparative Example. Thus, the optical element 100 is characterized by having less thermal lens effect and less thermal birefringence effect. This enables high-output and high-repetition use of the optical element 100. In particular, the coolant circulation section 140 is in surface contact with the Faraday rotation element 110 via the mirror 120 which is a thin film. As such, the coolant circulation section 140 is capable of removing, from the Faraday rotation element 110 within a short period of time, a large amount of heat resulting from laser irradiation. This enables high-output and high-repetition use of the optical

### Embodiment 2

The following description will discuss another embodiment of the present invention. Note that, for convenience of description, members having functions identical to those described in the above embodiment are assigned identical referential numerals, and their descriptions are not repeated.

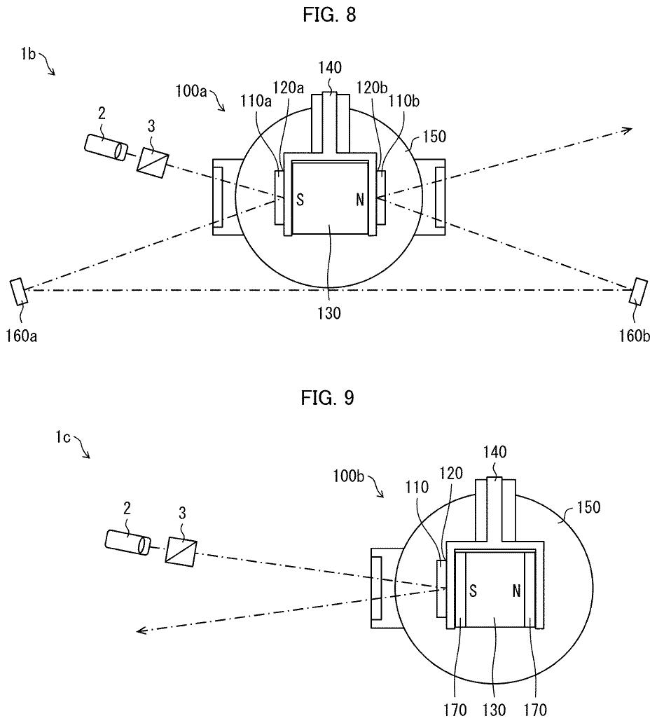

FIG. 7 is a view illustrating a configuration of main parts of an optical system 1a including an optical element 100a in accordance with Embodiment 2. FIG. 8 is a view illustrating a configuration of main parts of another optical system 1b including the optical element 100a in accordance with Embodiment 2. The optical element 100a includes Faraday rotation elements 110a and 110b, mirrors 120a and 120b, a magnet 130, a coolant circulation section 140, and a cryostat 150.

In the optical element 100 in accordance with Embodiment 1, a single Faraday rotation element 110 is provided so as to face either the south pole or the north pole of the magnet 130. In contrast, in Embodiment 2, in order to provide two Faraday rotation elements 110, the Faraday rotation elements 110a and 110b are provided respectively at the south pole and the north pole.

In FIG. 7, laser beams emitted from respective different laser light sources 2a and 2b enter the Faraday rotation elements 110a and 110b via a polarizing plate 3a or a polarizing plate 3b, reflected, and each reflected light is utilized. Thus, respective polarization planes of the two laser beams can be simultaneously rotated with respect to the single magnet 130. This enables reduction of cost by saving the costs of the magnet 130, the coolant circulation section 140, and the cryostat 150 which can each be shared. In this case, each of the Faraday rotation elements 110a and 110b preferably exhibits a rotation angle of 45° when the laser beams pass therethrough.

In FIG. 8, a plurality of mirrors 160a and 160b are provided with respect to the optical element 100a. A laser beam emitted from a single laser light source 2 enters the Faraday rotation element 110a via a polarizing plate 3, reflected, and the reflected light is reflected by the mirror 160a. The reflected light from the mirror 160a is further reflected by the mirror 160b. Then, the reflected light from the mirror 160b enters the Faraday rotation element 110b, reflected, and exits the optical element 100a. As a result, the laser beam emitted from the single laser light source 2 is rotated by the two Faraday rotation elements 110a and 110b. This makes it possible to reduce respective thicknesses of the Faraday rotation elements 110a and 110b with respect to a required rotation angle. This makes it possible to construct the optical system 1b at low cost. In this case, each of the Faraday rotation elements 110a and 110b preferably exhibits a rotation angle of 22.5° (with the two Faraday rotation elements, a total of 45°) when the laser beam passes therethrough.

### Embodiment 3

FIG. 9 is a view illustrating a configuration of main parts of an optical system 1c including an optical element 100b in accordance with Embodiment 3. As illustrated in FIG. 9, the optical element 100b in accordance with Embodiment 3 differs from Embodiment 1 in that, unlike the optical element 100, the optical element 100b includes a heating section 170 which heats a coolant circulation section 140.

The heating section 170 has a function of heating the coolant circulation section 140. That is, the heating section 170 such as a heater is fixed to a copper block in which a pipe for passing a coolant therethrough is formed. As a result, it is possible to heat a Faraday rotation element 110 whose temperature is monotonously decreased by the coolant down to a temperature of the coolant. This makes it possible to control (fix) the temperature to be constant at a predetermined temperature.

This temperature regulating function by the heating section 170 maintains the temperature of the Faraday rotation element 110 constant, and thus makes it possible to maintain a desired Verdet constant. This makes it possible to rotate a polarization plane at an intended rotation angle. It is therefore possible to obtain the optical element 100b which is capable of accurately rotating the polarization plane.

### Embodiment 4

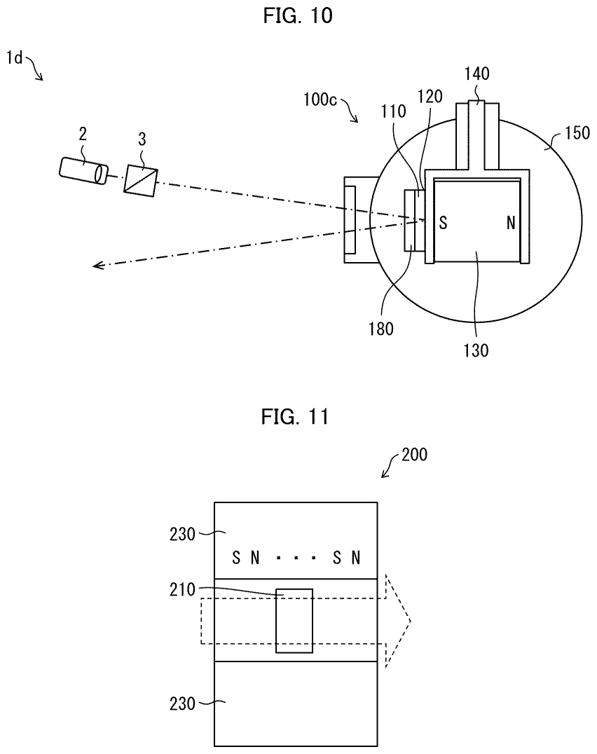

FIG. 10 is a view illustrating a configuration of main parts of an optical system 1d including an optical element 100c in accordance with Embodiment 4. As illustrated in FIG. 10, the optical element 100c in accordance with Embodiment 4 differs from Embodiment 1 in that, unlike the optical element 100, the optical element 100c includes a heat dissipation section 180 which dissipates heat of a Faraday rotation element 110.

The heat dissipation section 180 is a heat dissipation plate which is in contact with a surface of the Faraday rotation element 110 through which surface incident light enters, and dissipates heat of the Faraday rotation element 110. The heat dissipation section 180 may be made of sapphire or the like.

The heat dissipation section 180 provides an improvement in ability to cool the Faraday rotation element 110, and makes it easy to keep a temperature of the Faraday rotation element 110 low. This makes it possible to provide a Faraday rotation element having a high Verdet constant.

### Variation

Embodiments 1 to 4 have shown examples in which both the coolant circulation section 140 and the cryostat 150 are provided. It is possible, however, that only one of the coolant circulation section 140 and the cryostat 150 is provided. That is, it is only necessary that the Faraday rotation element 110 can be cooled by at least the coolant circulation section 140 or the cryostat 150.

Regarding wavelength, a wavelength to be allowed to enter the optical element 100 is not particularly limited. As a matter of course, in a case where the wavelength varies, the Verdet constant also varies. Therefore, in the experimental results indicated in Embodiment 1, there is no limitation on the temperature, the thickness of the Faraday rotation element, etc.

Aspects of the present invention can also be expressed as follows:

In order to attain the object, an optical element in accordance with Aspect 1 of the present invention is an optical element, including: a Faraday rotation element that is reflective and rotates a polarization plane of reflected light with respect to a polarization plane of incident light; a magnet provided on a side opposite to a surface of the Faraday rotation element through which surface the incident light enters the Faraday rotation element; and a cooling section provided between the Faraday rotation element and the magnet, the cooling section cooling the Faraday rotation element.

The above configuration makes it possible to provide the Faraday rotator (optical element) which achieves a high Verdet constant, by the provision of the cooling section, which cools the Faraday rotation element, between the Faraday rotation element and the magnet. Further, since the Faraday rotator is reflective, the polarization plane can be rotated at the time of entrance and at the time of reflection, respectively. As such, only a half of a length conventionally required is necessary, so that a reduction in volume of the magnet and a reduction in thickness of the Faraday rotator are achieved. This allows the optical element to have a small size.

An optical element in accordance with Aspect 2 of the present invention may be configured such that, in Aspect 1, the cooling section cools the Faraday rotation element by having liquid nitrogen passed through the cooling section. Further, the cooling section may be a cryostat.

According to the above configuration, the cooling section may be realized by cooling with use of liquid nitrogen as a coolant or realized with use of a cryostat. This makes it possible to cool the Faraday rotation element sufficiently.

In order to attain the object, an optical element in accordance with Aspect 3 of the present invention is an optical element, including: a Faraday rotation element that is reflective and rotates a polarization plane of reflected light with respect to a polarization plane of incident light; a magnet provided on a side opposite to a surface of the Faraday rotation element through which surface the incident light enters the Faraday rotation element; and a cooling section that cools the Faraday rotation element to a temperature of not higher than 200 K.

The above configuration makes it possible to cool the Faraday rotation element to a temperature of not higher than 200 K and to thereby obtain the Faraday rotator that achieves a high Verdet constant. Further, since the Faraday rotator is reflective, the polarization plane can be rotated at the time of entrance and at the time of reflection, respectively. This enables a reduction in volume of the magnet and a reduction in size of the optical element.

An optical element in accordance with Aspect 4 of the present invention may be configured such that, in any one of Aspects 1 to 3, the cooling section cools the Faraday rotation element to a temperature of not higher than 130 K. Further, the cooling section may cool the Faraday rotation element to a temperature of not higher than 110 K.

The above configuration makes it possible to further increase the Verdet constant of the Faraday rotation element.

An optical element in accordance with Aspect 5 of the present invention may be configured such that, in any one of Aspects 1 to 4, the cooling section controls the Faraday rotation element to have a predetermined temperature.

According to the above configuration, the cooling section is able to control (fix) the temperature of the Faraday rotation element to a predetermined temperature. This makes it possible to maintain a constant Verdet constant and to maintain a constant rotation angle of the polarization plane. This makes it possible to construct a low-loss optical system.

An optical element in accordance with Aspect 6 of the present invention may be configured such that, in any one of Aspects 1 to 5, the optical element further includes a heating section that heats the Faraday rotation element.

According to the above configuration, cooling by the cooling section and heating by the heating section make it possible to easily control (fix) the temperature of the Faraday rotation element to a temperature at which a desired Verdet constant is achieved. This makes it possible to construct a low-loss optical system.

An optical element in accordance with Aspect 7 of the present invention may be configured such that, in Aspects 1 to 6, the optical element further includes a heat dissipation section that is in contact with the surface of the Faraday rotation element through which surface the incident light enters the Faraday rotation element and that dissipates heat of the Faraday rotation element.

According to the above configuration, the heat dissipation section enables an improvement in ability to cool the Faraday rotation element, thereby making it possible to provide the Faraday rotator having a high Verdet constant.

An optical element in accordance with Aspect 8 of the present invention may be configured such that, in any one of Aspects 1 to 7, the Faraday rotation element is referred to as a first Faraday rotation element, and the optical element further includes a second Faraday rotation element provided on a side opposite to the first Faraday rotation element with respect to the magnet, the second Faraday rotation element being reflective and rotating a polarization plane of reflected light with respect to a polarization plane of incident light.

The above configuration allows two Faraday rotation elements to be provided with respect to a single magnet, and thus makes it possible to reduce the size and cost of the optical system.

An optical element in accordance with Aspect 9 of the present invention may be configured such that, in Aspect 8, the optical element further includes an element that reflects or refracts the reflected light from the first Faraday rotation element into the incident light which enters the second Faraday rotation element.

According to the above configuration, two Faraday rotation elements are provided with respect to a single magnet, and the polarization plane is rotated by a predetermined angle through two separate rotations with use of the two Faraday rotation elements. This makes it possible to reduce a rotation angle per Faraday rotation element. This allows each of the Faraday rotation elements to have a reduced thickness or have a reduced Verdet constant (have a higher temperature). This makes it possible to reduce costs and energy.

### Supplementary Note

The present invention is not limited to the embodiments, but can be altered by a skilled person in the art within the scope of the claims. The present invention also encompasses, in its technical scope, any embodiment derived by combining technical means disclosed in differing embodiments.

### REFERENCE SIGNS LIST

1, 1a, 1b, 1c, 1d: optical system
2, 2a, 2b: laser light source
3, 3a, 3b: polarizing plate
100, 100a, 100b, 100c, 200: optical element
110, 110a, 110b, 210: Faraday rotation element
120, 120a, 120b, 160a, 160b: mirror
130, 230: magnet
140: coolant circulation section (cooling section)
150: cryostat (cooling section)
170: heating section
180: heat dissipation section

1. An optical element, comprising:
a Faraday rotation element that is reflective and rotates a polarization plane of reflected light with respect to a polarization plane of incident light;
a magnet provided on a side opposite to a surface of the Faraday rotation element through which surface the incident light enters the Faraday rotation element; and
a cooling section provided between the Faraday rotation element and the magnet,
the cooling section cooling the Faraday rotation element.

2. The optical element as set forth in claim 1, wherein the cooling section cools the Faraday rotation element by having liquid nitrogen passed through the cooling section.

3. The optical element as set forth in claim 1, wherein the cooling section is a cryostat.

4. An optical element, comprising:
a Faraday rotation element that is reflective and rotates a polarization plane of reflected light with respect to a polarization plane of incident light;
a magnet provided on a side opposite to a surface of the Faraday rotation element through which surface the incident light enters the Faraday rotation element; and
a cooling section that cools the Faraday rotation element to a temperature of not higher than 200 K.

5. The optical element as set forth in claim 4, wherein the cooling section cools the Faraday rotation element to a temperature of not higher than 130 K.

6. The optical element as set forth in claim 4, wherein the cooling section cools the Faraday rotation element to a temperature of not higher than 110 K.

7. The optical element as set forth in claim 1, wherein the cooling section controls the Faraday rotation element to have a predetermined temperature.

8. The optical element as set forth in claim 1, further comprising a heating section that heats the Faraday rotation element.

9. The optical element as set forth in claim 1, further comprising a heat dissipation section that is in contact with the surface of the Faraday rotation element through which surface the incident light enters the Faraday rotation element and that dissipates heat of the Faraday rotation element.

10. The optical element as set forth in claim 1, wherein the Faraday rotation element is referred to as a first Faraday rotation element,
the optical element further comprising a second Faraday rotation element provided on a side opposite to the first Faraday rotation element with respect to the magnet, the second Faraday rotation element being reflective and rotating a polarization plane of reflected light with respect to a polarization plane of incident light.

11. The optical element as set forth in claim 10, further comprising an element that reflects or refracts the reflected light from the first Faraday rotation element into the incident light which enters the second Faraday rotation element.
